(19) United States
(12) Patent Application Publication
(10) Pub. No.: US 2025/0016710 A1
(43) Pub. Date: Jan. 9, 2025

(54) METHOD FOR TRANSMITTING AND RECEIVING MULTIMEDIA DATA

(71) Applicant: HEWLETT PACKARD ENTERPRISE DEVELOPMENT LP, Spring, TX (US)

(72) Inventors: Gianluca Verin, Pozzoleone (IT); Marco Sinibaldi, Vicenza (IT)

(21) Appl. No.: 18/710,906

(22) PCT Filed: Nov. 23, 2022
(86) PCT No.: PCT/IB2022/061350

§ 371 Date: May 16, 2024

(30) Foreign Application Priority Data
Nov. 23, 2021 (IT) 102021000029642

(51) Int. Cl. H04W 60/00; H04L 65/1045

(52) U.S. Cl. CPC H04W 60/00; H04L 65/1045

(57) ABSTRACT

A method for transmitting/receiving multimedia data between mobile devices comprising the steps: a) preparing a plurality of 4G and/or 5G mobile private networks each comprising a corresponding Home Subscriber Server (HSS) node for a 4G network or an Unified Data Management (UDM) for a 5G network, the mobile private networks of said plurality being mutually isolated to each other; b) preparing a plurality of mobile devices associated with users; c) registration of a group of mobile devices in the HSS or UDM node of a corresponding mobile private network to define groups of mobile devices whose connectivity is provided by separate and isolated mobile private network; d) preparing one or more central networks each comprising a corresponding HSS or UDM node and a corresponding Interrogating Call Section Control Function (I-CSCF) node; e) connecting one or more central network to two or more mobile private networks of said plurality. The method comprises a step f) of forwarding the registration of each user's mobile device already registered during execution of the step c) in the HSS or UDM node of one or more central networks.

### FIELD OF APPLICATION OF THE INVENTION

The present invention can be applied in the technical sector of the telecommunication networks and apparatus and concerns a method for transmitting/receiving digital multimedia data between two or more electronic devices, especially mobile devices.

### STATE OF THE ART

As it is known, 4G and/or 5G networks represent the current generation of broadband cellular network technology designed to provide a faster data connection between digital mobile devices as such smartphones, tablets, computers, IoT equipment, etc.

More specifically, the 4G/5G standard improves the network performance trough wider bandwidth, lower latency and very high integration of all apparatus in comparison to the standard of the previous networks.

In short, the key feature of the current 4G and 5G networks is the ability to be more flexible and adaptable to provide connection of a large number of devices which need to exchange a high data traffic to each other.

Mobile Private Networks (MPN) are stand-alone 4G and/or 5G cellular networks able to provide a private, secure and flexible data transfer among user's devices connected to them.

Each MPM is composed by a Radio and Core Network which enable data communication. The MPN can also comprise an IMS infrastructure (IP Multimedia Subsystem) that is specifically designed to provide real-time video/voice communication services for mobile apparatus associated with users and connected to the network.

The IMS infrastructure, when part of the MPN, allows the mobile apparatus connected to the MPN to communicate autonomously even if it is disconnected from the rest of the world.

Thus, through the IMS infrastructure is possible to share multimedia data (for instance voice and video over 4G/LTE—VoLTE or over 5G—VoNR) between two or more user devices connected to the same MPN.

The IMS infrastructure can provide connectivity between user devices registered in different isolated MPN or allow external calls by connecting to the PSTN (Public Switched Telephone Network) or (IP-Private Branch Exchange) IP-PBX via the SIP protocol (Session Initiation Protocol) or the or IP-PB protocol.

The blackhole is the part of the network infrastructure comprising hardware and software layers suited to mutually connect two isolated networks.

When the blackhaul is available, the connectivity between MPNs enables the services to be offered via the central IMS: i) mobile-to-mobile calls between user devices registered in different MPNs and in the central IMS, ii) mobile-to-mobile calls between user devices registered in one of the MPNs and in the central IMS, iii) external calls to the Public Switched Telephone Network (PSTN) via a SIP trunk connected to the central IMS.

The SIP trunk is based on the VoIP technology (Voice over Internet Protocol) which is also based on the SIP protocol for streaming media services between mobile devices connected to a cellular network.

To provide media data connectivity between a plurality of user devices, the MPNs and the central IMS comprise specific hardware/software nodes.

In particular, the IMS layer of a MPN comprises a Proxy-CSCF node (P-CSCF) that is a SIP proxy representing the closest connection point for the device associated with the user in the MPN.

Through the P-CSCF node is thus possible provide a direct connectivity between the user's device and the MPN.

Moreover, the RTP-Relay is a functionality co-located with and controlled by the P-CSCF node, that is suited to provide multimedia data transmission to/from a user's device during a call.

In addition, the MPN also comprises a Serving-CSCF node (S-CSCF node) placed upstream the P-CSCF node and suited to hand authentication/registration of the user's mobiles devices connected to the P-CSCF node.

The main aim of the S-CSCF node is to check that the user's device is already authenticated and, if so, promote his registration in the HSS node associated with to the same MPN where the user is authenticated.

The Home Subscriber Server node (HSS node) is substantially a database suited to store information associated with the user's profile.

The main drawback of having an IMS distributed in each MPN is the difficulty in establishing a multimedia connectivity between two or more user's devices associated with different MPNs. On the other hand, having a central IMS to which every MPN connects to, would not allow to make multimedia calls between user's devices registered in the same MPN in case the backhaul connection to the central MPN network becomes unavailable.

The solutions as described above are unable to guarantee survivability of the intra MPN calls when the backhaul connection is unavailable, and the inner calls when the backhaul connection becomes available.

“3^{RD} Generation Partnership Project; Technical Specification Group Services and System Aspects; Stage 2 (Release 17); IP Multimedia Subsystems”—3GPP Standard and “3RD Generation Partnership Project; Technical Specification Group Services and System Aspects; Stage 2 (Release 17); System architecture for 5G System (5GS)”—3GPP Standard, US2016/156783 and WO2021/093997 describe the specifications and functional interactions among the nodes of a 4G and/or 5G network; however, a network that complies with the instructions included in these document is affected by the same drawbacks already as described above.

### PRESENTATION OF THE INVENTION

The present invention aims to overcome the drawbacks cited above by providing an innovative method for transmitting/receiving digital multimedia data between two or more electronic devices.

More specifically, the main object of the present invention is to provide a method for transmitting/receiving digital data between two or more electronic devices suited to provide multimedia connectivity among a plurality of MPNs distinct and isolated to each other.

It is another object of the present invention to provide a method for transmitting/receiving digital multimedia data between two or more electronic devices suited to ensure connectivity between user's devices registered in different MPNs.

It is a further object of the present invention to provide a method for transmitting/receiving digital multimedia data between two or more electronic devices suited to provide a secure and stable connectivity over time, in particular when intra-NPN communication is needed regardless on whether the backhaul is available.

It is another object of the present invention to provide a method for transmitting/receiving digital multimedia data between two or more electronic devices that has substantially low complexity and does not require special adaptation to the infrastructure of the NPNs currently in use.

It is another, yet not the last objection of the present invention to provide a method for transmitting/receiving digital multimedia data between two or more electronic devices that has a very low cost impact and long time efficiency.

These objects, together with others that are highlighted in greater detail below, are achieved by a method for transmitting/receiving digital multimedia data between two or more electronic devices of the type claimed in claim 1.

Other objects that are better described below are achieved by the method for transmitting/receiving digital multimedia data between two or more electronic devices claimed in the dependent claims.

### BRIEF DESCRIPTION OF THE DRAWINGS

The advantages and characteristics of the present invention are clearly illustrated in following detailed description of a preferred but non-limiting embodiment of a method for transmitting/receiving digital multimedia data between two or more electronic devices, with particular reference to the following drawings, wherein:

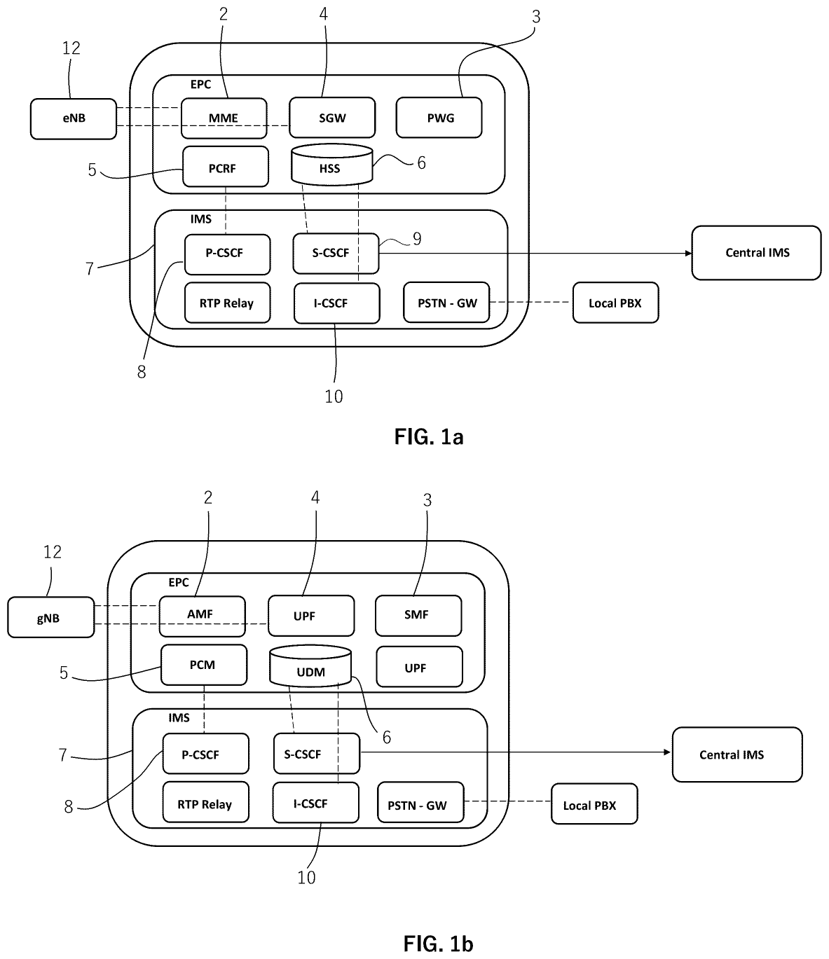

the FIG. 1a and FIG. 1b are general schemes of an architecture of a Mobile Private Network-MPN in the 4G and 5G configuration;

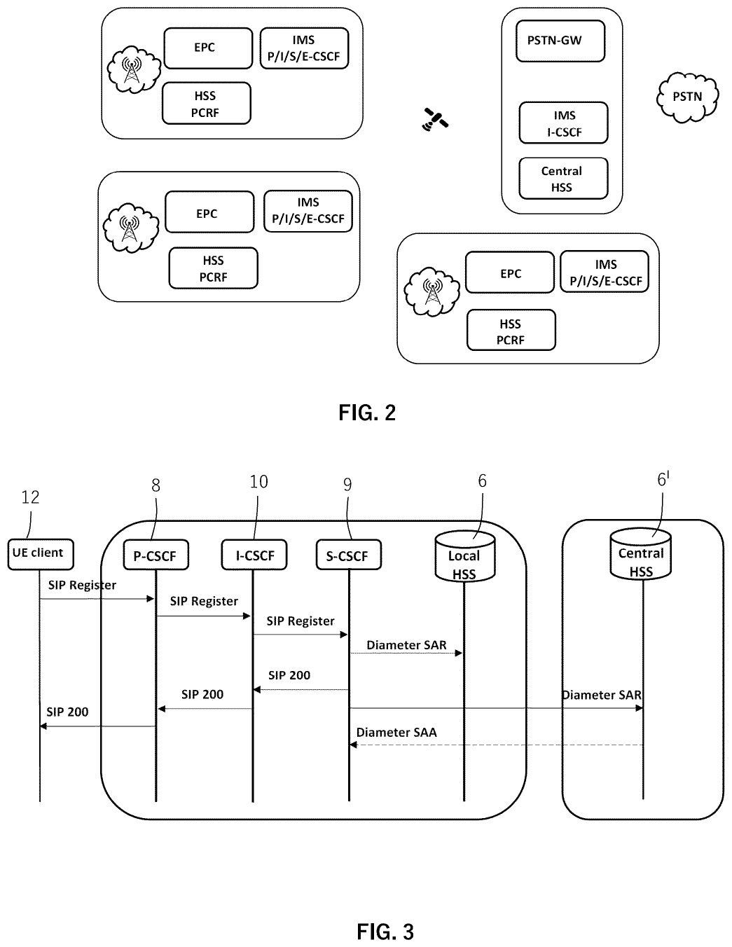

the FIG. 2 is a general scheme of the interconnection between MPNs and a central site, in case the backhaul is available;

the FIG. 3 is a general scheme where the user's device is registered for its presence in the local and central HSS/UDM;

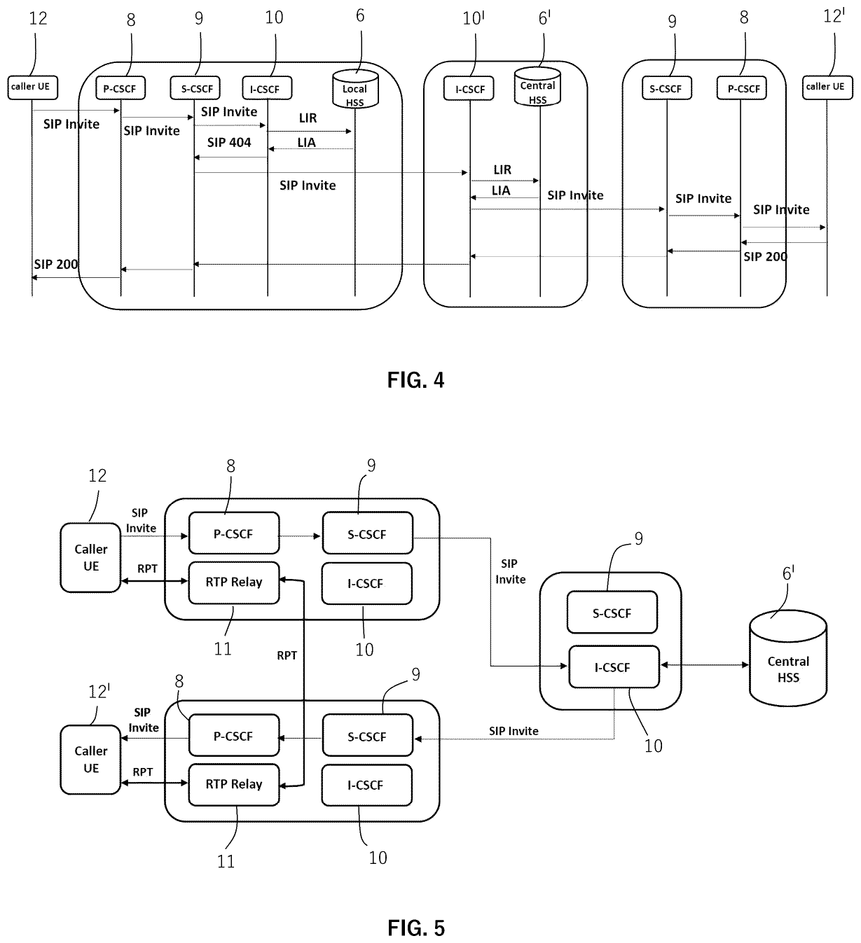

the FIG. 4 is a general scheme of the call procedure inter-IMS with the use a central IMS;

the FIG. 5 is a general scheme of a direct multimedia connectivity between two user's devices associated with respective MPNs which perform inter-IMS calling with the help of a central IMS for signalling and the multimedia flow connects directly the MPNs;

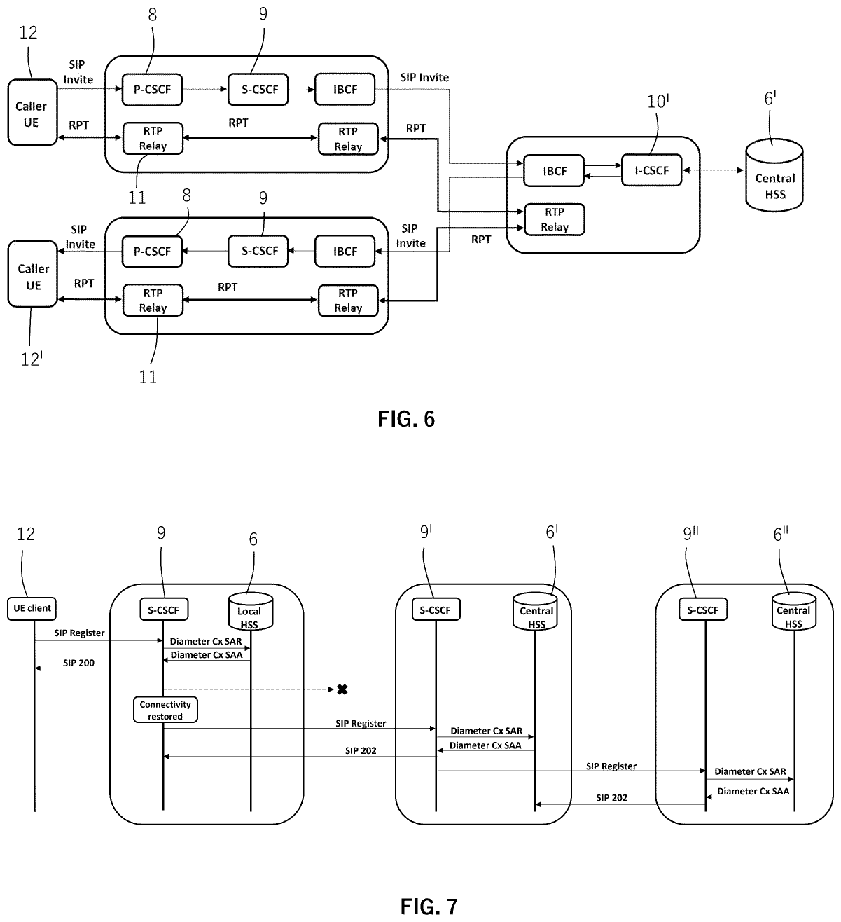

the FIG. 6 is a general scheme of a multimedia connectivity between two user's devices associated with respective MPNs via the central IMS for both signalling and multimedia data flow;

the FIG. 7 is a general scheme of a multi-level IMS architecture which include two or more hierarchical MPNs;

### DETAILED DESCRIPTION OF THE INVENTION

The present invention concerns to a method for transmitting/receiving digital multimedia data between two or more electronic devices associated with a wireless 4G and/or 5G networks.

More specifically, the present method is particularly suited to be applied to a plurality of 4G and/or 5G MPNs, as will be explained below.

According to the scope of the present invention, a mobile private networks (MPN) is an independent 4G and/or 5G network suited to provide connectivity to one or more users.

This type of network are specifically designed for providing connectivity in extreme conditions (i.e. emergency or military scenarios) when standard networks are not available and users need to establish high-speed rate connectivity.

According to the block diagram shown in FIG. 1a and FIG. 1b, the architecture of a MPN may be generalized as the union of two sub-architectures: a EPC/5GCN layer and a IMS layer.

EPC (Evolved Packet Core) 1 is suited to provide connectivity for a large number of heterogeneous mobile devices enabling their authentication/authorization and mobility support, and handling the billing policy.

This sub-infrastructure basically comprises the following nodes:
a Mobility Management Entity—MME node 2 (or an Access and Mobility Management-AMF node, in 5G equivalent technology);
a Packet Data Network Gateway—PGW node 3 (or a Session management Function-SMF+User Plane Function-UPF node, in 5G equivalent technology);
a Serving gateway—SGW node 4;
a Proxy Call Section Control Function—PCRF node 5 (or a Policy Control Function—PCF node, in 5G equivalent technology);
a Home Subscriber Server-HSS node 6 (or an Unified data Management-UDM node, in 5G equivalent technology).

The EPC sub-infrastructure for 4G networks is shown in the general scheme of FIG. 1a, whereas the EPC sub-infrastructure for 5G networks is shown in FIG. 1b.

The Mobility Management Entity node (MME/AMF node) 2 is responsible of the paging and authentication of the mobile device. This node retains information concerning the location of the user's device and selects the appropriate gateway during the control-plane node of the EPC.

PDN gateway node (PGW/SMF+UPF node) 3 is designed to connect the MPN to application services. Within the 5G core network the PDN gateway function is realized by the SMF (Session management function) and UPF (User plane function) for signalling a forwarding traffic data. The function of the PDN gateway node is to assign an IP address to each device connected to the 4G and/or 5G MPNs and to forward data traffic between the latter and the external networks/services.

A PDN Gateway node 3 may forward data traffic to different external services such internet services, voice services, etc.

In addition, the Serving gateway node (SGW node) 4 represents the anchor local point for a user's device and its main function is routing and forwarding data traffic. This node is typically located between a router and the PDN Gateway node. In the 5GCN this function is again performed by the SMF and UPF node.

The Policy and Charging Rules Function node (PCRF/PCF node) 5 provides rules for controlling the data flow, including Quality of Service setup.

The Home Subscriber Server node (HSS/UDM node) 6 is a user database that support IMS networks entities to handle the calls. This database contains at least the user profiles and is suited to perform the user authentication and authorization. In addition, the HSS/UDM node is suited to provide information about the user's location and IP information.

Each MPN comprises an IMS infrastructure (IP Multimedia Subsystem) that is specifically designed to provide real-time video/voice communication services for mobile apparatus associated with users and connected to the network.

The IMS infrastructure allows the mobile apparatus connected to the MPN to communicate autonomously even if it is disconnected from the rest of the world.

Thus, through the IMS infrastructure is possible to share multimedia data (for instance voice and video over 4G/LTE—VoLTE or over 5G—VoNR) between two or more user devices connected to the same MPN.

The IMS layer 7 include at least the following nodes:
A P-CSCF node 8;
A S-CSCF node 9;
An I-CSCF node 10;

The A Proxy-CSCF node (P-CSCF node) 8 is a proxy representing the first point of contact for the user's device.

The P-CSCF and the RTP-Relay nodes 8 are suited to forward all data traffic to/from the user's device, and then processes and forwards the responses addressed to the user's device.

The P-CSCF node 8 is thus the node suited to provide connectivity between the MPN and the user's device.

The transmission/reception of multimedia data between the user's device and the P-CSCF node 8 is provided through the Real-time Transport Protocol (RTP) which is a specific protocol developed to enable real-time communication of data exchanged between the network and the application installed in the user's device.

For this reason, the P-CSCF node 8 is often shown combined with a RTP-Relay node 11 that is able to handle the multimedia part of a communication between the user's device and the network.

The Serving-CSCF node (S-CSCF node) 9 is the node responsible for session control. This node handles the authentication/registration of the user's devices connected to the network.

The S-CSCF node 9 is connected to the HSS/UDM node 6 to share authentication/registration users information to identify which is Application Server to send the requests.

A user's device connected to a P-CSCF node 8 reaches a corresponding S-CSCF node 9 configured to control the authentication/registration of the user through a connection with a HSS node.

The Interrogating-CSCF node (I-CSCF node) 10 is responsible for forwarding messages to the corresponding S-CSCF node 9 associated with to the given user's device.

When between two different user's devices a call is established, the S-CSCF node 9 associated with the caller and the S-CSCF node 9 associated with the callee are mutually connected through a corresponding I-CSCF node.

The I-CSCF node 10, after being interrogated by the S-CSCF node 9 associated with the caller, retrieves information concerning the S-CSCF node 9 associated with the callee (via connection with the HSS/UDM) and then forwards the data to the latter for establishing the call between two user's devices.

The method claimed in the present invention comprises a step a) of preparation of a plurality of 4G and/or 5G networks.

During execution of the step a) a plurality of MPN of the type discloses below may be prepared.

Each MPN may be isolated from another mobile private network and may include an IMS layer 7 comprising, at least, a P-CSCF node 8, a S-CSCF node 9 and a I-CSCF node 10.

The MPN prepared in the step a) may thus considered, from the point of view of the connectivity, as isolated “bubbles” suited to mutually connect only the electronic devices or apparatus authenticated to them.

Each network MPN prepared in the step a) include a HSS/UDM node 6. The expression “local HSS/UDM” used in the following of this description refers to a HSS/UDM node 6 co-located with the IMS 7 and part of a MPN. In the reminder of this description, the expression “local HSS node” is used to indicate a local node which can be selected from HSS or UDM nodes depending on the type of MPN network prepared in the step a) [4g network or 5G network].

Each MPN prepared in the step a) comprises a single local HSS node 6 that is included within the EPC layer of such MPN network.

As a result of step a), a plurality of MPN networks are obtained; these MPN's network are designed to arrange a plurality of independent isolated “bubbles”, each of which included a single local HSS node 6.

As described above, the HSS/UDM node 6 is a database comprising at least the following information:
user profiles;
the registration/authentication/authorization of each user;
the location associated with each user.

The method comprises a step b) suited to provide a plurality of mobile devices 12 associated with a respective user.

Opportunely, the mobile devices 12 associated with the users may be any electronic apparatus (smartphones, tablets, laptop, etc) suited to be connect to a network via WiFi.

Moreover, the electronic devices 12 associated with the users may be specifically developed to connect to a network based on 4G and/or 5G technologies via WiFi.

The method also comprises a step c) of registration of a group of the user's devices 12 in the HSS/UDM node 6 of a corresponding MPN.

After execution of the step c) a group of user's devices 12 will be associated with a single MPN in order to transmit/receiving data traffic through it.

In other words, the connectivity of each group of user's devices 12 is provided by the corresponding MPNs to which the same are connected.

The execution of the step c) provides the registration of one or more user's data (profile/authentication/authorization/location/etc.) to the single local HSS node of the corresponding MPN to which the user's device is associated.

The registration step c) disclosed in this method is shown in the block scheme of FIG. 3.

When the device 12 registers in the step c), it sends a SIP REGISTER message to the IMS layer 7 of the MPN.

The SIP REGISTER is a message according to the Session Initiation Protocol required by the 3GPP standard, this message includes a request for associating the device 12 to a corresponding MPNs.

The SIP REGISTER message is associated with the user's data (profile/authentication/authorization/location/etc.) to be registered in the local HSS node to which the user's device is connected.

The SIP REGISTER propagates within the MPN and, in particular, is generated by the user's device 12 and sent to the P-CSCF node 8 of the MPN.

Then, the SIP REGISTER propagates from P-CSCF note 8 to the I-CSCF node 10; and from the I-CSCF node 10 to the S-CSCF node 9.

The S-CSCF node 9 is suited to send a Diameter Cx SAR message to the local HSS 6 of the MPN.

Also the Diameter Cx SAR message is a message according to the 3GPP standard and it is associated with the user's data (profile/authentication/authorization/location/etc.) to be registered in the local HSS node 6 to which the user's device 12 is connected.

Once a Diameter Cx SAR message has been received, the local ISS 6 saves (or records) all relevant information concerning the user's device 12.

The step c) is completely executed when all information associated with a Diameter Cx SAR message has been saved (or recorded) in the local ISS node 6.

Opportunely, the registration step c) of a user's device 10 may be periodically repeated to determine an updated mapping of the devices 12 actually registered to the local HSS 6 of a corresponding MPN.

A periodically repetition of the step c) allows to detect which and how many devices 12 are in real-time registered to the local HSS 6 of each MPN as users may move over time and the number of the devices 12 associated with the networks varies accordingly.

The step c) allows to carry out a “first registration phase” of the user's device 12: at the end of the step c) all of user's mobile data (profile/authentication/authorization/location/etc.) is registered in the local HSS node 6 of the corresponding MPN to which the devices 12 are associated.

In other words, at the end of the step c) it is possible to recognize:
a plurality of isolated MPN networks;
a predetermined number of user's devices 12 associated with each of MPN of said plurality;
each MPN has a single local HSS node 6 on which the data of all user's mobile devices 12 connected to the MPN has been registered (or recorded).

As shown in FIG. 3, the method comprises a step d) of preparation of one or more central networks each comprising, at least, a corresponding HSS/UDM node 6′. The expression “central HSS” used in the following of this description refers to a HSS node 6′ included in the central network. In the reminder of this description, the expression “central HSS node” is used to indicate a local node which can be selected from HSS or UDM nodes depending on the type of central network prepared in the step d) [4g network or 5G network].

Each central network prepared in step d) is completely isolated from the plurality of MPN network arranged in the step a).

In addition, the step e) of the method allows to provide a connection between the one or more MPN to a set of MPNs. This connection is provided by one or more central networks prepared in step e).

This arrangement is schematically shown in FIG. 2.

In this case three distinct MPNs define respective “bubbles” which are connected to a single central network (i.e. a satellite radio access or a radio link or even a fiber link).

Opportunely, the central site may be operatively connected to a Public Switched telephone Network (PSTN), which is the common technical expression to define the infrastructure for public telecommunication, especially voice data and multimedia data.

One or more user's devices 12 registered to a corresponding MPN may forward/receive data traffic to/from the PSTN via the central network.

The network design shown in FIG. 2 defines a hierarchical structure: all MPN are at a basic level (level 0) while the central networks (that is the network where a plurality of MPNs are connected) forms an upper level (level 1).

All networks defining the basic level (MPNs) are connected to the network defining the upper level (central network).

This arrangement repeats in a modular way when two or more central networks are provided.

The central networks define a plurality of a hierarchical levels, from level 1 (occupied by the central network connected to the MPNs) to level N (occupied by the central network at the top of the hierarchy).

This arrangement is schematically shown in FIG. 7 where there are two central networks mutually connected (in this case, the local HSS 6 on the left occupy the level 0, the first central HSS 6′ at the centre occupy the level 1 and the second central HSS 6″ on the right occupy the level 2).

According to a peculiarity characteristic of the present invention, the method comprises a step f) of forwarding a registration message associated with a user's device 12 (already registered to a local HSS/UDM node 6) to one or more the central HSS/UDM 6′.

The step f) may be executed substantially simultaneously to the registration step c) or later.

The simultaneous execution of the steps c) and f) allows for a real-time copy of the user's mobile 12 registration in both local HSS node 6 and central HSS node 6, 6″. In this case, the registrations contained the central HSS 6, 6″ are completely aligned with the registration contained in all local HSS node 6 associated with the plurality of MPNs, as the central HSS node 6′, 6″ is updated without delay as soon as one or more registrations are changed in the local HSS nodes 6.

The simultaneous execution of the forwarding step f) and the registration step c) minimizes the delay for updating the central HSS node 6′, 6″ and ensures that the central HSS nodes 6′, 6″ comprise, at a specific instant of time, all set of registrations that were registered in the local HSS 6 of the MPNs in same instant of time.

As schematically shown in FIG. 3, during execution of the step f) the S-CSCF node 9 may forward the registration message to:
The local HSS/UDM 6 to create an association of the user's device 12 with the MPN;
The HSS/UDM 6′ of the central network located hierarchically above the MPN and operatively connected thereof.
The aim of the step f) is essentially to duplicate the registration of each user's device 12 to a respective MPN for the central network which will therefore have the location of each user's device in each connected MPN.

User information stored in the local HSS 6 after the execution of the step c) will also be copied in the central HSS/UDM 6′ of the central network due to the execution of step f).

After the step f), the information associated with a registration of each user's device is available at the HSS 6′ of each central network.

During execution of the step f) the information associated with the user's data (profile/authentication/authorization/location/etc.) is also recorded in the central HSS 6, 6″ of the central network or of each central networks.

The step f) allows to carry out a “second registration phase” of the user's devices 12: in this case all data associated with the user's mobile (profile/authentication/authorization/location/etc.)—which is already registered in the local HSS node 6 of the MPNs—is also registered in the central HSS node 6′, 6″ of the one or more central network prepared in step e).

At the end of the step f) it is possible to recognize:
a plurality of isolated MPN networks;
a predetermined number of user's mobile devices 12 associated with each of MPN of said plurality;
a single local HSS node 6 associated with each of MPNs, data associated with all user's mobile devices 12 connected to the MPN is registered (or stored, or recorded) on the local HSS 6,
one or more central networks;
a single central HSS node 6′, 6″ associated with each central network, the user's mobile data already registered on all local HSS nodes 6 is also registered on each central HSS 6′, 6″.

After the execution of the step f), the information associated with the user's mobile devices 12 connected to all MPNs are registered (or copied, or recorded, or saved) on the central HSS 6′, 6″.

The method for transmitting/receiving digital multimedia data between two or more electronic devices 12 disclosed in this specification defines some specific technical features that have not disclosed in the state of the art.

Firstly, for applying the subject method is necessary to prepare two different types of HSS nodes: a plurality of local HSS nodes 6 (associated with the MPNs) and one or more central HSS nodes 6′, 6″ (associated with the central networks) that are distinct and isolated from the local HSS.

The 4G and/or 5G standard only require the preparation of the local HSS nodes 6, but for the implementation of the subject invention a preparation of one or more central HSS node 6′, 6″ is required.

Moreover, the method introduces a hierarchy between the HSS nodes: the local HSS 6 are at the lowest level (level 0) and the central HSS nodes 6′, 6″ are at a higher level (level 1 or more) than local HSS nodes 6. The local HSS nodes 6 monitor the registration status of the user's devices 12 at the lowest level, that is the registration of all user's devices associated with a determined MPN. It is important to the that every MPN is isolated from other MPNs, so that the local HSS node 6 only monitors the registration of the user's device connected to the same MPN to which such local HSS node 6 is connected. A local HSS node 6 does not monitor (and does not take into account) the registration status of the user's mobile devices 12 connected to a MPN different with respect to the MPN to which such local HSS node 6 is connect.

The aim of the step f) is to propagate upwards (forwarding) the registration status. Thus, the information associated with the user's device 10 registration is forwarded from the lowest level (level 0—local HSS node 6) to a higher level of the hierarchy (level N—central HSS nodes 6′, 6″).

The 4G and/or 5G standards do not provide for propagation of the registration status associated with the user's devices 12.

The forwarding step f) allows to define a redundancy on the information associated with the user's devices 12. This redundancy is stored from the level 1 to the level N of the hierarchy to keep the registration status updated the central HSS nodes 6′, 6″.

As further describe below, redundancy on the registration status allows a connection to be established between two user's mobile device 12 associated with different (and isolated) MPNs.

4G and/or 5G standard do not provide for a connection between two user's mobile devices 12 via additional HSS nodes (other than the HSS nodes included in a MPN) associated with one or more central networks at a higher hierarchical level than the private networks MPN.

This duplication of the information is particularly useful when two devices associated with different MPNs establish a call.

The method also comprises a step f) of connecting two mobile devices 12 associated with different MPNs. These devices 12 are connected due to registration information saved (or recorded) in the HSS or UDM node 6′, 6″ during execution of the step f).

As described below, the connection between two user's mobile device 12 established in the step f) is based on the propagation of a SIP invite request provided for according to the 3GPP standard.

During the execution of the step f), the SIP invite request follows a path starting from the caller (or calling) user mobile 12 and terminates to the callee (or called) user mobile 12 passing through the one or more central HSS nodes 6′, 6′.

In particular, the central HSS node 6′, 6″ are always involved when the caller mobile 12 and the callee mobile 12 are associated with two different MPNs.

In this case, the SIP Invite request is opportunely addressed (or forwarded) to the central HSS nodes 6′, 6″, as the latter contain all the registration information associated with the callee mobile 12 and updated at the time of the request.

Thus, the step f) is strictly connected to the step f) and both operate synergically: firstly, step f) duplicates all registration status on the central HSS nodes 6′, 6″; secondly, the step f′) arranges a connection between two distinct user's devices 6′, 6″ using the registration status previously recorded on the central HSS nodes 6′, 6″.

The step f′) clarify the aim of the step f): a real-time copy on the central HSS nodes 6′, 6″ of the registration status of the user's device 12 to the corresponding local HSS nodes 6 is used as a basis for connecting originally isolated devices 12 (because they are associated with different MPN) by forwarding the SIP request message (provided by the 3GPP standard) via the central HSS 6′, 6″ (which are constantly updated on the registration status of all user's devices 12).

After execution of the step f), a connectivity is established between two distinct (and originally isolated) user's devices, so that multimedia data can be transmitted/received between them.

A preferred implementation of the step f′) is disclosed below. In this case, step f) is based on a set of further steps (or sub-steps) from g) to m).

It is important to note that the step f) described below is to be considered a particular implementation among a number of different possibilities suited to provide a connectivity between two isolated user's devices 12 by forwarding a specific request passing through the central HSS nodes 6′, 6″.

The method comprises a step g) of sending an invite message generated by a caller user's device and addressed to a callee user's device.

According to the 3GPP standard, this message may be a SIP Invite request generated from the caller device 12 and addressed to the callee user's device 12.

As shown in the block scheme of FIG. 4, the SIP invite request initially propagates from the caller device 12 to the local HSS 6.

The SIP Invite request is generated by the user's device 12 and propagates to the local HSS 6 following this order: from the device 12 to the P-CSCF node 8, from the P-CSCF node 8 to the S-CSCF node 9, from the S-CSCF node 9 to the I-CSCF node 10 and from the latter to the local HSS 6.

The method provides for a step h) of determination whether the callee user's mobile 12 addressed by the SIP invite request generated in said step g) is included into the group of the devices 12 already registered in the local HSS 6 during the execution of the step c).

If the callee device 12′ is included in this group (that is the callee device 12′ is one of those previously associated with the MPN) the local IMS 6 will address a corresponding invite request to the callee device 12′ by its propagation through the I-CSCF node 10, the S-CSCF node 9 and the P-CSCF node 8.

This configuration is shown in FIG. 4: the I-CSCF node associated with the MPN sends a Location-Info-Request message (LIR) to the HSS/UDM node of the same MPN which sends a Location-Info-Answer Diameter message (LIA) to the I-CSCF node indicating a successful user location query procedure.

The above procedure is generally followed for providing connectivity between two mobile devices associated with the same MPN that need to establish a call.

However, the steps claimed in the present method are specifically designed to forward a call request between two user's devices 12 associated with different MPN (which may be completely isolated to each other).

After the step f) above-mentioned, the method comprises a step i) of forwarding the SIP Invite coming from the caller device 12 to the I-CSCF node 10′ associated with the central network.

The execution of the step i) is conditioned by the step g): the step i) is carried out only if the outcome of the step g) is negative.

Step g) is negative when the callee device 12′ is not included in the same MPN to which the caller device 12 is associated.

The negative outcome of the step g) is a necessary condition to carry out the step i); in this step i) the SIP Invite message is forwarded from the S-CSCF node 9 of the MPN to which the caller device 12 is associated, to the central network.

In particular, the SIP Invite message sent by the S-CSCF node 9 of the MPN is received by the I-CSCF node 10′ of the central network.

The I-CSCF node 10′ of the central network interrogates the central HSS 6′ for receiving information regarding the callee device 12′ and, in particular, regarding the MPN to which the same is associated.

The method comprises a specific step l) suited to extract the information concerning the MPN to which the callee device is associated.

During execution of the step l), a comparison between the information included in the SIP Invite message and the information saved in the central HSS/UDM 6′ is made.

This configuration is shown in FIG. 4: the I-CSCF node associated with the central network sends a Location-Info-Request message (LIR) to the HSS/UDM node of the same central network which sends a Location-Info-Answer Diameter message (LIA) to the I-CSCF node indicating a successful user location query procedure.

The outcome of this comparison allows to perform the further step m) of the method wherein a new SIP invite request is sent from the I-CSCF node 10′ of the central network to the MPN to which the callee user's device is associated. Thanks to the registration status of all user's mobile devices 12 recorded in the central HSS node 6′, 6″ it is possible to carry out the comparison step l) in order to recognise the callee MPN to which the SIP Invite request should be addressed.

In particular, the step m) is suited to forward new SIP invite request generated by the I-CSCF node of the central network to the callee device associated with a MPN of destination.

This arrangement is shown in FIG. 4.

The new SIP Invite request may be sent from the I-CSCF node of the central network to the S-CSCF node of the MPN to which the callee device is associated.

After the step m), the method comprises a step n) wherein the new SIP Invite request coming from the central network is forwarded from the S-CSCF of the MPN to the corresponding P-CSCF node 8 of the same network and, finally, to the callee device 12′.

The procedure described above and based on the steps f), g) and i) allows to establish a call between two devices (caller 12/callee 12′) associated with different MPNs.

The described method allows to provide connectivity between user's devices 12, 12′ associated with different MPNs without increase the complexity of the data infrastructure.

In addition, the procedure disclosed in the present method is particularly focused to exchange multimedia data between user's devices 12, 12′ registered to different MPNs.

The execution of the steps a)-n) does not require a modification of the structure of a IMS network; in particular the network infrastructure remains substantially the same as that of a normal IMS network in accordance with the 3GPP standard.

For this reason, the disclosed method is particularly flexible and efficient since it can be easily implemented in any existing 4G and/or 5G network without requiring specific adaptations/upgrades.

The steps previously disclosed are specifically designed to initiate a call between a caller device 12 associated with a MPN to a callee device associated to another MPN 12′.

When a call between two devices 12, 12′ is established, the streaming of multimedia data may follow the same path or a different path than that the path followed by the SIP Invite request.

In general, the streaming of the multimedia data is exchanged between the user's mobile 12, 12′ in accordance with the RTP protocol.

When the P-CSCF nodes 8 of two distinct MPNs have a direct IP visibility, these nodes may exchange multimedia data therebetween.

FIG. 5 shows this network arrangement.

During the call, the streaming of multimedia data generated by a user's device 12, 12′ is forwarded to the corresponding P-CSCF node 8 of the MPN to which the device is registered.

Then, the RTP Relay functionality node 11 associated with the same node P-CSCF node 8 is responsible to directly forward the streaming of multimedia data to the RTP Relay 11 associated with the P-CSCF node 8 of the MPN of the other user's device involved in the call.

After reaching the RTP Relay 11 of the other MPN, the streaming of the multimedia data will be forwarded to the user's device 12′, 12.

Thus, FIG. 5 procedure shows a particular arrangement of the networks wherein the SIP Invites follow the path defined by the step a)-n) of the method and the streaming of the multimedia data follows another a distinct path defined by the direct IP visibility of the RTP Relay nodes 11.

In this case the I-CSCF node 10′ of the central network is not involved in forwarding the streaming of the multimedia data.

The arrangement of the networks shown in FIG. 6 covers the case wherein there is not direct IP visibility between the P-CSCF nodes 8 associated with the corresponding MPNs.

In this case the streaming of the multimedia data substantially follows the path of the SIP Invite request.

In this case the I-CSCF node 10′ of the central network is not involved in forwarding the streaming of the multimedia data.

FIG. 7 schematically shows the procedure for establishing a call according to the present method and referring to a hierarchical network arrangement.

In particular, a first central network is placed upstream the MPN and a second central network is placed upstream to the first central network.

In this case the execution of the registration step f) also provide a copy of a registration information of a user's device 12 associated with the mobile private networks to both the central HSS node 6′, 6″ of the first central network and of the second central network.

The registration procedure is duplicated in each hierarchical level of the central networks.

The registration procedure is duplicated at each hierarchical level of the core networks.

Similarly, the procedure provided by the method for establishing a call between a caller device and a callee device (steps g)-n)) follows the hierarchical structure imposed by the network configuration.

In this case, therefore, all SIP Invite requests will be forwarded by the caller device to the S-CSCS node 9 of the MPN and subsequently by the latter to the I-CSCF node 10 of the first core network.

The I-CSCF node 10 of the first MPN will forward the SIP Invite request also to the I-CSCF node 10 of the second MPN which, thanks to the information contained in the corresponding HSS/UDM node 6″, will send the request to the MPN to which the callee device is associated.

The present invention can be carried out in other variants, all falling within the scope of the inventive characteristics claimed and described herein; these technical details can be replaced by different technically equivalent elements and materials e/o technologies; the shapes and sizes of the invention can be any, provided that they are compatible with its intended use.

The reference numbers and signs included in the claims and in the description have the only purpose of making the text easier to understand and must not be considered as elements limiting the technical interpretation of the objects or processes they identify.

1. A method for transmitting/receiving multimedia data between mobile devices, said method comprising the following steps:
a) preparing a plurality of 4G and/or 5G mobile private networks each comprising a corresponding Home Subscriber Server (HSS) node (6) for a 4G network or a Unified Data Management (UDM) for a 5G network, the mobile private networks of said plurality being mutually isolated to each other;
b) preparing a plurality of mobile devices (12) associated with users;
c) registration of a group of mobile devices (12) in the HSS or UDM node (6) of a corresponding mobile private network to define groups of mobile devices (12) whose connectivity is provided by separate and isolated mobile private networks;
d) preparing one or more central networks each comprising a corresponding HSS or UDM node (6′, 6″) and a corresponding Interrogating Call Section Control Function (I-CSCF) node;
e) connecting said one or more central network to two or more mobile private networks of said plurality;
characterized in that it comprises
a step f) of forwarding to the HSS or UDM node (6′, 6″) of said one or more central networks the registration of each user's mobile device (12) already registered during execution of the step c); and
a step f) of connecting two mobile devices associated with different private networks, the connection between said users' mobile devices (12) associated with different private networks being carried out by the registration saved in the HSS or UDM node (6′, 6″) of said one or more central networks during execution of the step f).

2. Method as claimed in claim 1, characterized in that each mobile private network comprises at least a Proxy Call Section Control Function (P-CSCF) node (8), an Interrogating Call Section Control Function (I-CSCF) node (10) and a serving Call Section Control Function (S-CSCF) node (9).

3. Method as claimed in claim 1 or 2, characterized in that each of said central network comprises an Interrogating Call Section Control Function (I-CSCF) node (10′) operatively connected to the HSS or UDM node (6′, 6″).

4. Method as claimed in claim 2 or 3, characterized in that in said step c) a registration request propagates, respectively, from each the user's mobile device (12) to the Proxy Call Section Control Function (P-CSCF) node (8), from the Proxy Call Section Control Function (P-CSCF) node (8) to the Interrogating Call Section Control Function (I-CSCF) node (10), from the Interrogating Call Section Control Function (I-CSCF) node (10) to the Serving Call Section Control Function (S-CSCF) node (9), from the Serving Call Section Control Function (S-CSCF) node (9) to HSS or UDM node (6) of the corresponding local mobile private network to which the mobile device is registered.

5. Method as claimed in any claims from 2 to 4, characterized in that in said step f) a registration request associated with each mobile device is also propagated from the Serving Call Section Control Function (S-CSCF) node (9) of the corresponding mobile private network to the HSS or UDM node (6′, 6″) associated with one or more central network.

6. Method as claimed in one or more of the preceding claims, characterized in said step f) comprises a step g) of sending a Session Initiation Protocol (SIP) Invite signal from a calling user's mobile device (12) to a HSS or UDM node (6) associated with the mobile private network to which the same calling device is registered.

7. Method as claimed in claim 6, characterized in that in said step g) the Session Initiation Protocol SIP invite signal propagates, respectively, from the user's mobile device (12) to the Proxy Call Section Control Function (P-CSCF) node (8), from the Proxy Call Section Control Function (P-CSCF) node (8) to the Serving Call Section Control Function (S-CSCF) node (9), from the Serving Call Section Control Function (S-CSCF) node (9) to the Interrogating Call Section Control Function (I-CSCF) node (10), from the Interrogating Call Section Control Function (I-CSCF) node (10) to HSS or UDM node (6) of the corresponding mobile private network to which the calling mobile device (12) is registered.

8. Method as claimed in one or more of the preceding claims, characterized in that said step f) comprises a step i) of forwarding the Session Initiation Protocol (SIP) invite signal coming from the calling user's mobile device (12) to the Interrogating Call Section Control Function (I-CSCF) node (10′) of one or more central networks.

9. Method as claimed in claim 8, characterized in that in said step i) the Session Initiation Protocol (SIP) invite signal is forwarded from the Serving Call Section Control Function (S-CSCF) node (9) associated with the mobile private networks to which the calling mobile device (12) is registered, to the Interrogating Call Section Control Function (I-CSCF) node (10′) associated with the one or more central network.

10. Method as claimed in claim 8 or 9, characterized in that said step f) comprises a step l) of determining the mobile private network to which the callee mobile device (12) is associated, said step l) being carried out by comparing the information included in the Session Initiation Protocol (SIP) invite signal with the information saved in the HSS or UDM node (6′, 6″) associated with the one or more central network.

11. Method as claimed in any claims from 8 to 10, characterized in that said step f) comprises a step m) of forwarding the Session Initiation Protocol (SIP) invite signal to the mobile private networks to which the callee mobile device (12) is registered.

12. Method as claimed in claim 11, characterized in that said step m) is carried out forwarding the Session Initiation Protocol (SIP) invite signal from the Interrogating Call Section Control Function (I-CSCF) node (10′) of the one or more central network to the Serving Call Section Control Function (S-CSCF) node (10) of the corresponding mobile private networks to which the callee device (12) is registered, being also provided a step n) of propagating of the Session Initiation Protocol (SIP) invite signal from the Serving Call Section Control Function (S-CSCF) node (9) to the Proxy Call Section Control Function (P-CSCF) node (8) and from the Proxy Call Section Control Function (P-CSCF) node (8) to the callee user's mobile device (12).
